(19) United States
(12) Patent Application Publication
(10) Pub. No.: US 2024/0140229 A1
(43) Pub. Date: May 2, 2024

(54) ELECTRIC VEHICLE CHARGING SYSTEM USING CHARGING ROBOTS

(71) Applicant: EVJAM LLC, Minneapolis, MN (US)

(72) Inventors: Gregg KROMREY, Hudson, WI (US); Steven DICKE, Minneapolis, MN (US)

(73) Assignee: EVJAM LLC, Minneapolis, MN (US)

(21) Appl. No.: 18/385,316

(22) Filed: Oct. 30, 2023

Related U.S. Application Data
(60) Provisional application No. 63/420,476, filed on Oct. 28, 2022.
(60) Provisional application No. 63/420,479, filed on Oct. 28, 2022.
(60) Provisional application No. 63/420,878, filed on Oct. 31, 2022.
(60) Provisional application No. 63/422,494, filed on Nov. 4, 2022.

(51) Int. Cl. B60L 53/35; B60L 53/14; B60L 53/67; G06Q 10/0631; H02J 7/00

(52) U.S. Cl. CPC B60L 53/35; B60L 53/14; B60L 53/67; G06Q 10/0631; H02J 7/0042; H02J 7/0071; G05D 1/6895

(57) ABSTRACT

One example provides an electric vehicle charging system including a system controller to communicate with a plurality of electric vehicles, each electric vehicle requesting a charging operation to charge a vehicle battery pack of the electric vehicle, the system controller to generate a charging schedule including an order in which the electric vehicles are to be charged based on a plurality of charging factors, and to select from the charging schedule an electric vehicle for charging. The charging system includes at least one autonomous charging robot having a charging battery pack, the charging bot to drive to the selected electric vehicle as directed by the system controller, the charging robot including an interface unit to automatically couple to a charging port of the selected electric vehicle and charge the vehicle battery pack from the charging battery pack.

### CROSS REFERENCE TO RELATED APPLICATIONS

This Non-Provisional patent application claims the benefit of the filing date of U.S. Provisional Patent Application Ser. No. 63/420,476, filed Oct. 28, 2022, U.S. Provisional Patent Application Ser. No. 63/420,479, filed Oct. 28, 2022, U.S. Provisional Patent Application Ser. No. 63/420,878, filed Oct. 31, 2022, U.S. Provisional Patent Application Ser. No. 63/422,494, filed Nov. 4, 2022, all of which are herein incorporated by reference.

### TECHNICAL FIELD

The present disclosure relates generally to examples of electric vehicles and to devices and systems for use with electric vehicles, including electric vehicle batteries, electric vehicle charging devices, and electric vehicle charging systems.

### BACKGROUND

Electric vehicles (EVs), such as automobiles (e.g., cars and trucks), watercraft, all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a rechargeable battery system, one or more electrical motors, each with a corresponding electronic power inverter (sometimes referred to as a motor controller), and various auxiliary systems (e.g., cooling systems). To enhance ownership and ensure availability, charging of EVs should be both timely and convenient.

For these and other reasons, there is a need for the present invention.

### SUMMARY

The present disclosure provides one or more examples of an electric vehicle and systems and/or devices for use with an electric vehicle, including battery charging systems.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems.

FIG. 1 is a block and schematic diagram generally illustrating an electric vehicle charging system, according to examples of the present disclosure.

FIG. 2 is a block and schematic diagram generally illustrating portions of an electric vehicle charging system, according to examples of the present disclosure.

FIG. 3 is a block and schematic diagram generally illustrating a side view of a charging robot, according to examples of the present disclosure.

FIG. 4 is a block and schematic diagram generally illustrating an end view of a charging robot, according to examples of the present disclosure.

FIG. 5 is a block and schematic diagram generally illustrating a charging robot, according to examples of the present disclosure.

FIG. 6 is a block and schematic diagram generally illustrating a charging robot, according to examples of the present disclosure.

FIG. 7 is block and schematic diagram generally illustrating a perspective view of a charging interface unit, according to examples of the present disclosure.

FIG. 8 is block and schematic diagram generally illustrating a charging interface unit, according to examples of the present disclosure.

FIG. 9 is a block and schematic diagram generally illustrating portions of an electric vehicle charging system, according to examples of the present disclosure.

FIG. 10 is block and schematic diagram generally illustrating a charging interface unit, according to examples of the present disclosure.

FIG. 11 is block and schematic diagram generally illustrating a charging interface unit, according to examples of the present disclosure.

FIG. 12 is block and schematic diagram generally illustrating a charging interface unit, according to examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

### Overview

EV Charging System with Charging Bot

An EV charging system could be residential or commercial. Could be set in most any parking location. In a commercial version, the EV charging system could be set in a parking lot, parking facility or part of a parking facility. In a residential application, the charging system could be located in a garage or near a house. A charging bot can be used for automatic charging of one or more vehicles located in the facility. A charging control system coordinates charging of one or more vehicles. The control system can communicate with the electric vehicle and/or a user app.

EV Charging System with Power Bus

A commercial EV charging system which may simultaneously charge multiple vehicles includes an EV charging control system and at least an AC Power Bus extending along or across a number of EV parking spaces of a parking facility. In other examples, the EV charging system may include an AC Power Bus and/or a DC Power Bus. The AC Power bus may extend above the parking spaces (e.g., at a front, at a middle, or at a rear of the parking spaces). The parking facility may be a surface parking lot or a parking ramp. The AC Power Bus may have capacity to simultaneously charge multiple EVs. Upon parking, a driver of an EV communicates with the EV charging controller to indicate that the driver wishes to have the EV's battery charged. In one case, the driver may select whether the requested charge is to be via an AC charge or a DC charge (e.g., a fast charge). In some cases, the driver communicates with the DC charging controller via a transceiver, where each parking space has a corresponding transceiver which indicates the EV's location to the EV charging controller. In some cases, the driver communicates via the transceiver using an app installed on an electronic device (e.g., on a smartphone or on a computer system integral to the EV). Such communication may include various data for proper and safe charging of the EV, such as vehicle type (make & model), battery type, available charging options (e.g., AC and DC charging), a current state of charge (SOC) of the battery, charging port/receptacle location on the vehicle, etc., as well as payment information (e.g., credit card information). Additionally, a driver may enter a time by which the driver expects to depart (i.e., a time by which a requested charging operation needs to be complete). Based on the information provided, the EV charging controller may communicate to the driver the expected time by which the charging operation will be completed and the price of the charging operation. If the completion time and/or price of the charging operation is not satisfactory, a driver may cancel the charging operation request. Based on the information of each EV which has requested a charging operation (e.g., the type of charge (AC or DC), the SOC, and the time by which the charge needs to be completed (e.g., the expected departure time of the EV), the EV charging control system determines an order of charging of the EVs to optimize the number of EVs which can be charged in a given period of time. In other examples, the vehicles are simply charged on a first come, first serve basis. The EV charging control system may communicate the expected completion time of the charging time to the driver. The EV charging control system may provide updates to the drivers of the EV via a smartphone application as to the status of the charging operation, either automatically or upon request by the drivers. In some cases, if a driver parks in a “charging zone” and attempts to schedule a battery charging operation, but the charging zone is already at a charging capacity (e.g., the system is unable to charge the vehicle within the requested time window due to the number of cars already scheduled for charging), the EV charging control system may direct the driver to other charging zones within the facility which are able to charge the vehicle within the desired time frame.

Charging robots. The EV charging system may include a number of charging robots (CBots) which are configured to automatically connect to and perform the requested charging operation of the EV. In some cases, each CBot is arranged to carry out one charging operation at a time, where a number of CBots together enable the system to simultaneously carry out multiple charging operations, where the number of simultaneous charging operations able to be performed depends on an electrical capacity of the EV charging system.

In some implementations, the CBots run on a track system which extends along parking spaces of the parking facility. The track system may be wall mounted, ceiling mounted, surface mounted (e.g., on a surface of a parking lot or ramp). In some cases, the electric power bus (e.g., AC and/or DC) may also be employed as part of the track system along which the CBots run. In examples, each CBot may be assigned to a number of parking spaces (a “charging zone”) such that each CBot is able to run back-and-forth along a segment of the track/power bus corresponding to its assigned parking spaces. In examples, the CBot includes an on-board rectifier to convert the AC power from the AC power bus to DC power to provide DC fast charging capabilities. In some cases, according to the charging schedule developed by the EV charging control system, the CBot moves along the track to the parking space corresponding to the EV to be charged. Depending on the scheduled charge type, the CBot will either provide an AC or a DC connection to the EV. In some cases, the CBot includes an articulating arm that includes a selectable connector type for connecting to the connector type of the EV to be charged. In some cases, upon reaching the parking space of the EV to be charged, the CBot communicates with the EV to carry out the charging operation. In some examples, such communication includes instructing the EV to open a cover or door to expose the EV's charging port/receptacle. In some cases, the CBot automatically senses and locates the EV charging receptacle and inserts the charging plug into the EV charging receptacle. In some cases, such sensing may be optical. In other cases, a driver of the EV may insert a charging port extender/adapter that provides a receptacle/connector that is compatible with the plug(s) of the CBot (e.g., a adapter that provides an AC and/or DC receptacle compatible with the AC and/or DC plug/connector of the CBot. Upon connecting the charging cable to the EV, the AC or DC power, as required, is provided to the EV from the power bus via the CBot. In examples, power to operate the CBot is derived from the AC power bus. Upon completion of the charging operation, the EV charging control system may notify the owner/driver that the charging operation is complete, the CBot disconnects the power cord/plug/connector from the EV, retracts the articulating arm, and moves along the AC power bus to the required location to perform the next charging operation.

In other cases, the CBots may be autonomous CBOTs (a-CBots), which are free of a track system and which are configured to “drive” to any parking space within the parking facility to perform a scheduled charging operation. In such case, the a-CBot may include an onboard battery-powered electric and control system to drive and maneuver the a-CBot to the parking space to which it is directed by the EV charging control system to perform a charging operation. Upon reaching the designated parking space, the a-CBot connects with a first articulating arm to the AC power bus, and connects a charging cord to the charging port of the EV using a second articulating arm (similar to that described above).

In other examples, in lieu of the charging system employing a power bus, the CBots carry an onboard battery for charging the EVs, wherein the onboard battery has a capacity to fully charge at least one vehicle. The CBot/EV charging control system monitors the state of charge (SOC) of the CBot's onboard battery. Upon the SOC of the CBot dropping below a predetermined charge level, the CBot drives to a central battery facility where it automatically exchanges the depleted battery with a fully charged battery (e.g., which is stored on a battery rack system) and returns to scheduled charging of EVs in the charging facility. After placing the depleted battery on the battery rack, the depleted battery is recharged by a charging system located within the central battery facility. In examples, a fleet of CBots operates to charge EVs parked within the parking/charging facility and shares the supply of batteries maintained within the central battery facility. In this fashion, a total number of batteries which is less than double the number of CBots may be employed (e.g., with a fleet of 10 CBots, the central battery facility may maintain a total of 15 batteries, where 10 are mounted to and being used by the CBots at a given time). In examples, the central battery facility may employ DC fast charging to recharge the supply of CBot batteries. Such a charging system does not require power bus(es) to be installed throughout the parking facility and can be employed in any number of types of parking facilities (e.g., parking ramps, surface parking lots, etc.).

In another case the Charging System can include a-CBots with a charging rack. This type of Charging System can include one or more of the following features:
The charging system can include one or more a-cbots.
Each a-CBot can be responsible for charging multiple vehicles over a charging period.
This type of charging system is great for servicing a charging room, floor, partial floor or multiple floor parking facility (i.e., a charging facility).
Each a-CBot has an on-board vehicle charging battery.
The charging facility would have one or more charging locations. For example, there could be one centralized charging location or one or more charging locations dedicated to a charging area.
An a-CBot can have a restore mode where it moves to a charging location and charges its vehicle charging battery at the charging location. The vehicle charging battery can be “quick-charged” or slow charged.
Once charged, the a-CBot transitions to a vehicle charging mode where it moves to a designated vehicle to perform a vehicle charging process.
An a-CBot can move between a restore mode and a vehicle charging mode multiple times over a 24 period, charging multiple vehicles over that time period.
In the vehicle charging mode, a designated vehicle can be slow charged or quick charged depending on a number of vehicle factors.
The a-CBot can run off of the vehicle charging battery or a separate battery. Both batteries can be charged when the a-CBot is in restore mode.
An a-CBot may or may not include an AC/DC converter.
The charging facility can include a battery charging system that includes a charging rack. The charging rack operates to charge and store vehicle charging batteries.
A vehicle charging battery is moveable between a charging rack and an a-CBot.
In one case, the a-CBot can move a vehicle charging battery onto a charging rack. In another case, the battery charging rack loads the vehicle charging battery from the a-CBot onto the battery charging rack.
In operation, once a vehicle requests a charge an a-CBot loads a fully charged vehicle charging battery from the rack onto the a-CBot. The a-CBot then moves to the location of the EV making the charge requests and performs a vehicle charge operation.
Once complete, the a-CBot returns to the battery charging rack location and loads the empty battery (i.e., not fully charged) onto the charging rack at an open location on the rack. The a-CBot can then move to another rack location that contains a fully charged battery. The a-CBot then loads the fully charged battery and moves to another electric vehicle location to fill another vehicle charge request.
This system can utilize more a-CBots with fewer batteries. For example, a parking facility could have 10 a-CBots and 15 vehicle charging batteries. Up to 10 vehicle charging batteries could be actively used at a given time, with 5 batteries in reserve being charged on the charging rack.
If there was a given time where a charged vehicle charging battery was not available from the charging rack, the a-CBot could enter a wait mode until it was notified that a charged battery was available for use.
Charging systems using a-CBots with vehicle charging batteries are suitable for many different charging facility applications, including locations where it is not feasible to located power rails, etc within the charging facility.

The CBots can interface directly with the vehicle, or through a separate CBOT interface unit. The CBot interface unit can be plugged into the EV's charging port, and located (e.g., at the front or back of the vehicle) at a position that allows for direct access by the CBot.

The EV charging system may include multiple a-CBots, where a number of CBots together enable the EV charging system to simultaneously carryout multiple charging operations of multiple EVs, where the number of simultaneous charging operations able to be performed depends on an electrical capacity of the EV charging system.

Example EV charging systems with CBot applications include the following applications:
Ev charging station with charging bot (cbot)
Residential charging station with cbot
Parking facility charging station with cbot
Commercial charging station with cbot
Smart cbot
Cbot with battery
Cbot that operates on a floor/flat surface
Cbot that operates along a wall, column system or post system.
Cbot that moves between a floor and wall/post system.
Cbot/ev control system that communicates between the ev/bot/user. The user can communicate via any user interface (e.g., computer, tablet, phone or control pad).
The cbots could also be drone cbots

In examples, in lieu of the CBots including an onboard AC-DC rectifier to enable DC fast charging, the EV charging system includes both an AC bus and a DC bus, where the DC bus is powered via a centralized AC-DC power supply.

In other examples, in lieu of employing CBots, each parking space may have a corresponding power cord which is manually connected to the EV by the driver. Each power location has an assigned address by which the EV charging control system controls the timing and order in which the charging operations of the EVs in the parking facility are charged, wherein the EV charging system individually controls which addressable power cord is activated for charging based on the developed charging schedule.

### One Example Garage CBot EV Charging Sequence

The CBot could have one or more of the following features:
CBot senses vehicle, and then wakes up vehicle charging controls.
CBot could sense vehicle by a number of methods including motion detector or other sensing method. Once sensed (even if false detection) bot sends out EV wake-up signals.
EV enters garage space/bot wakes up EV charging system/EV activates charging mechanism/charging tray.
CBot leaves CBot rest position/location. CBot could be wired or leave a CBot station. CBot moves to charging position with EV.
In one example, CBot uses charge plug active positioning to get very close to alignment with charging tray.
Next CBot charge plug secures to charge tray. In one example, CBot plug secures to charge tray using magnetic coupling.
when charging complete, CBot turns off magnetic coupling to remove from charging position.
CBot returns to rest station.
CBot could be used to charge one vehicle or multiple vehicles. Or for example, there could be 2 CBots that charge up to 10 vehicles over night, etc.

### One Example CBot Design

Cbot can include:
Control system that interface with ev and/or ev app
Electric motor
Power System including Battery/may include AC-DC converter
Ev interface arm (that electrically couples to ev)
Power grid interface arm (that electrically couples or aids in coupling to power grid/rail system/etc)
Movement system that allows free or restricted or designated movement of cbot-(wheels, or attachment to frame system)

Cbot could charge at the same time ev is charged or charged at its own charging station. Cbot could be electric but not battery powered.

In a commercial ev charging facility or a ramp charging facility the cbots could run on a mechanical rail system (e.g., located along the walls) and be kept off the parking facility floor.

Electric vehicles (EVs), such as automobiles (e.g., cars and trucks), watercraft, all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems).

One or more examples of the present application provide an electric vehicle. In one example, the electric vehicle includes an electric vehicle battery and other electric vehicle systems and devices. One or more examples further provide an electric vehicle charging system for simultaneously charging multiple electric vehicles. One or more features of electric vehicle systems, devices, and charging systems are described in further detail in the following paragraphs and illustrated in the Figures.

Electric Vehicle Charging System with Charging Robots

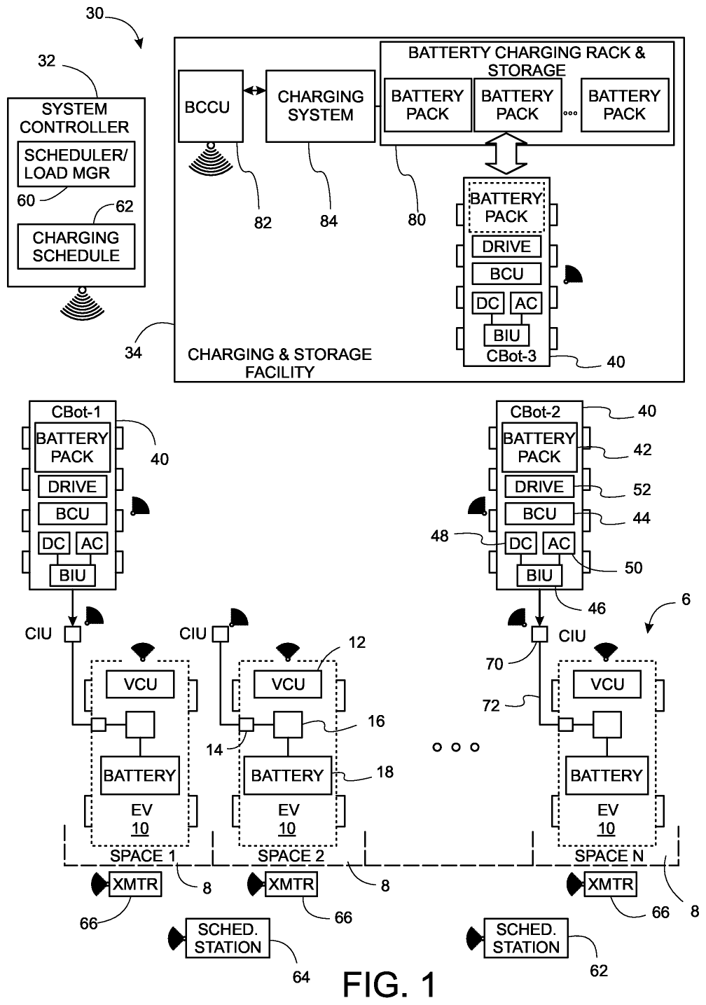

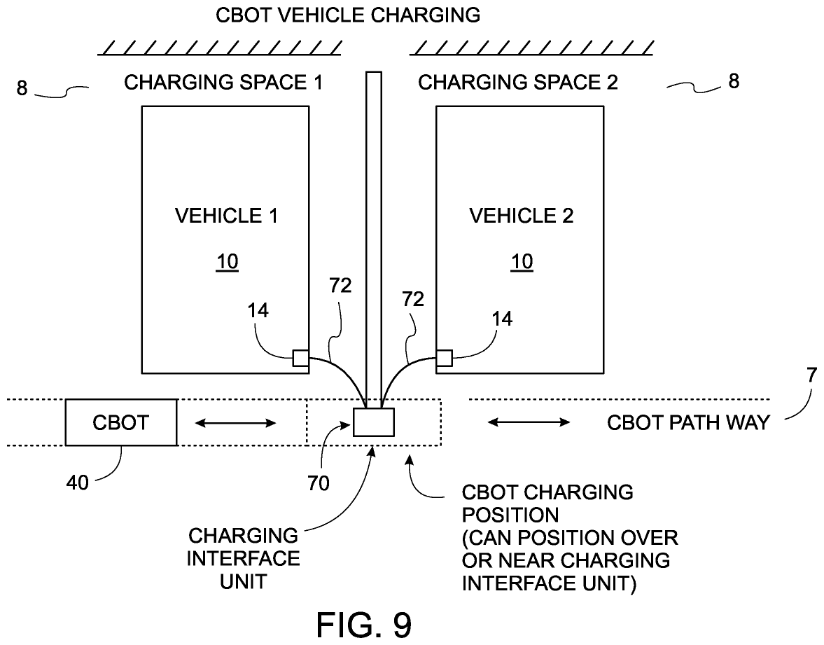

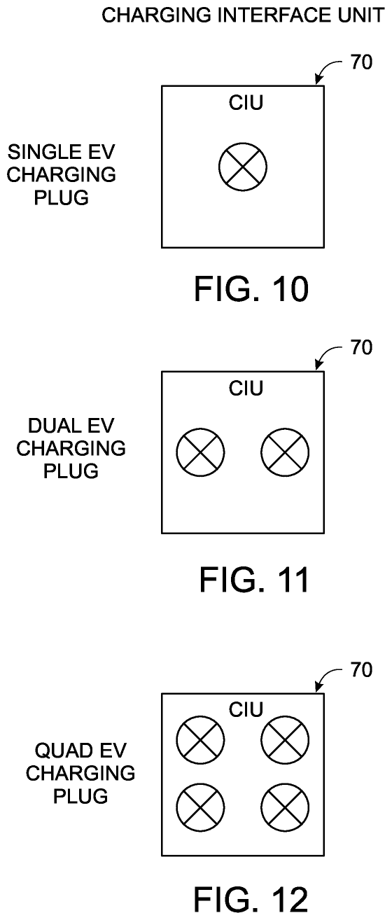

FIGS. 1-12 below illustrate and describe an EV charging system 30 employing autonomous electric vehicle charging robots (CBots), according to examples of the present disclosure.

The present disclosure provides an EV charging system for simultaneously charging multiple EVs. The EV charging system may be employed in any suitable parking facility, such as parking ramps and surface parking lots, for example, and may be employed both as part of newly constructed parking facilities or adapted for use in existing parking facilities. The parking facility may any type of parking facility, such as a public parking facility (e.g., shopping centers), a corporate parking facility (e.g., associated with a business, such as manufacturing facility r a hotel), and a commercial parking facility (e.g., a pay facility)—any type of parking facility where EVs will be parked for extended time periods (e.g., for an hour or more) while the drivers are occupied with other tasks (e.g., shopping, dining, attending a sporting event, working, etc.). In examples, the parking facility may include parking for both EVs and non-electric vehicles.

FIG. 1 is a block and schematic diagram generally illustrating EV charging system 30, according to one example of the present disclosure. EV charging system 30 includes a system controller (SC) 32, a battery pack charging and storage facility 34, and one or more CBots 40 (illustrated as CBots 1-3 in FIG. 1) for charging a number of EVs 10 parked in a parking facility 6, such as a parking ramp or surface parking lot, for instance. In examples, each EV 10 includes an onboard vehicle control unit (VCU) 12, a charging port 14, a battery charger 16, and a rechargeable battery 18.

In some cases, parking facility 6 includes a number of parking spaces 8 (indicates as spaces 1-n in FIG. 1), where, in examples, such parking spaces 8 may be used for parking both EVs and non-electric vehicles. In examples, system controller 32, CBots 40, and components of the battery pack charging and storage facility 34 are in communication with one another (as well as with EVs 10) using any suitable communication technique including hardwired communication and wireless communication (e.g., Bluetooth, cellular, radio, etc.).

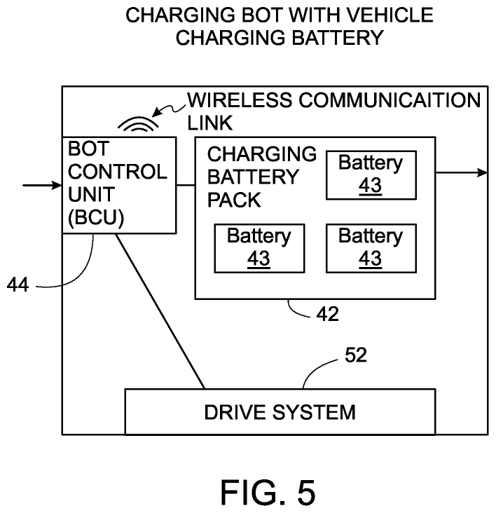

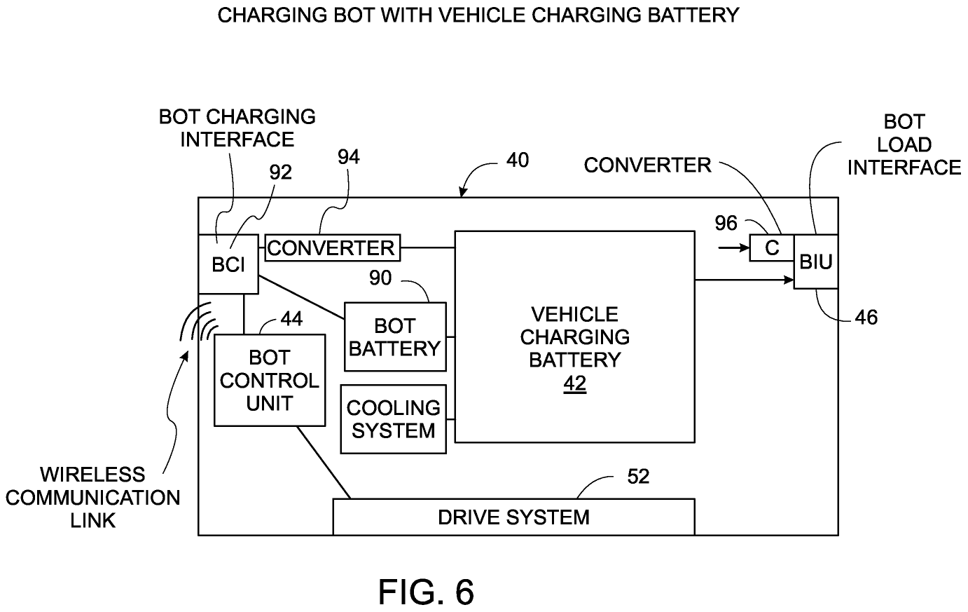

In examples, each CBot includes an exchangeable charging battery pack 42, and an onboard bot control unit (BCU) 44, a bot interface unit (BIU) 46, a DC-DC converter/interface 48, a DC-AC converter/interface 50, and battery-powered drive system 52 (see also FIGS. 5-6 below) which is controlled by BCU 44 to autonomously drive and maneuver CBot 40 throughout parking facility 6, including through battery pack charging and storage facility 34.

In examples, system controller 32 directs the one or more CBots 40 to maneuver to the locations of EVs 10 within parking facility 6 that have requested charging, where, upon reaching the designated location (e.g., a designated parking space 8), the CBot 10 automatically connects to and charges the EV 10 using the onboard charging battery pack 42. Upon the charging battery pack 42 becoming depleted (e.g., below a predetermined threshold charge), the CBot 10 automatically maneuvers to the battery pack charging and storage facility 34 to obtain a fresh charging battery pack 42 (i.e., a charged battery pack).

### Example Operation

### System Controller/Scheduler

In examples, system controller 32 includes a scheduler and load management module 60 (referred to hereinafter simply as scheduler 50). In examples, scheduler 60 comprises computer executable instructions that when executed by system controller 32 cause system controller 32 to carryout scheduling and load management operations of EV charging system 30, as described in greater detail below. Upon entering parking facility 6, the driver of an EV 10 communicates with system controller 32 to request/schedule a battery charging operation. In one case, the driver may communicate with system controller 32 via an application installed on a computing device, such as a smartphone or an onboard computing device (e.g., vehicle controller 12) of EV 10. In another case, the driver may communicate with the system controller 32 via one or more scheduling stations 64, which may be disposed at various locations throughout parking facility 8 (e.g., in proximity to parking spaces 8).

Communication between EV 10 and system controller 32 may include any number of various scheduling data/parameters to enable proper and safe charging of EV 10 and enable system controller 32, via schedule 60, to determine a charging schedule 62 for CBot charging operations that enables the greatest number of EVs 10 to be charged within a given time period. In some cases, such scheduling information may include technical information, such as vehicle type (e.g., vehicle make & model), battery type, available charging options (e.g., Level 1, Level 2, DC fast charging), a current state of charge (SoC) of the EV battery 18, charging port 14 type/configuration, and additional information such as a location of the EV 10 within parking facility 6 (e.g., a number of the parking space 8), a license plate of the EV 10, a time by which the the driver needs to the have the charging operation completed, driver payment information (e.g., credit card information), and driver contact information (e.g., smartphone number, email address), for example.

In examples, based on such information, the system controller 32, via scheduler 60, determines a dynamically adjustable charging schedule 62 for the EVs 10 within the facility which have currently requested and confirmed that a battery charging operation be carried out. In examples, based on the information provided by the driver, and based on the current charging schedule 62, system controller 32 determines an adjusted charging schedule and communicates to the driver the expected time by which the requested charging operation will be completed and the price of the charging operation. In some examples, if more than one type of charging operation is available for the EV, in addition to the requested type of charging operation (e.g., a Level 2 charging operation), system controller 32 may also communicate a price and an expected completion time of an alternate charging operation type (e.g., a DC fast charging operation).

If the expected completion time and/or price of the requested (or alternate) charging operation is not satisfactory, the driver may cancel the requested charging operation and the current charging schedule 62 is not adjusted by system controller 32. In some examples, if a charging operation is not scheduled, system controller 32 charges the driver a fee for parking in the parking facility based on a rate schedule. If the driver accepts the charging operation (either the requested charging operation or an alternate charging operation), system controller 32 updates/replaces the current charging schedule 62 with an adjusted charging schedule 62 and provides confirmation of the estimated completion time and the price of the accepted charging operation to the driver. In some examples, system controller 32 may communicate charging status updates to the driver (e.g., scheduled times and schedule updates/adjustments, expected completion time of the charging operation, and charging operation completion, etc.).

By employing a dynamically adjustable charging schedule 62, EV charging system 30, in accordance with the present disclosure, is able to charge a maximum number of EVs 10 in a given time period using a given number of CBots 40 while meeting the completion time of the charging operation as designated by the drivers of EVs 10. Furthermore, EV charging system 30 enables drivers to charge EVs 10 at times where the EV will otherwise be idle (e.g., while performing other activities such as working, shopping, attending a sporting event, etc.).

### CBot Operation

In examples, system controller 32 directs each CBot 40 to carry out battery charging operations of specified EVs 10 in parking facility 6 in accordance with the charging schedule 62 dynamically maintained and adjusted via execution of scheduler 60. After being assigned to perform a charging operation of an EV 10, a CBot 40 assigned to the charger operation by system controller 32 autonomously drives itself to the identified location of the assigned EV 10. In some examples, each EV 10 may be identified via a parking space 8 in which the EV 10 is parked. In other examples, each EV 10 may be identified by its license plate number. In one example, each parking space may have a corresponding transmitter 66 which identifies the corresponding parking space 8. In some cases, the CBot 40 may include an optical system to identify the assigned EV 10 (e.g., a license plate) or the parking space 8 in which the assigned EV 10 is parked (e.g., a number on the pavement and/or on a post/wall, etc.). In some cases, the CBot 40 may wirelessly communicate with the transmitting device 66 the location of the assigned EV 10. In some cases, the CBot 40 may communicate wireless with the EV itself or identify the parking space 8 in which the assigned EV 10 is parked (e.g., via an RFID tag or Bluetooth transmitting device disposed at and corresponding to the parking space).

In examples, upon reaching the designated EV 10, the CBot 40 automatically connects to the charging port 14 of the EV 10 via the bot interface unit (BIU) 46 on the CBot 40. After connecting to the assigned EV 10, the CBot 40 carries out a connection protocol with the EV 10 and/or system controller 32 to verify that a proper connection has been made, to verify that it is indeed the EV 10 designated for charging, and to verify the type of charging operation to be performed (e.g., Level 1, Level 2, DC fasting charging, etc.). In some examples, the CBot 40 includes onboard DC-DC converter/interface unit 48 to perform designated DC charging operations, and an onboard DC-AC converter/interface unit 50 to perform designated AC charging operations.

In examples, upon completing the connection protocol and verifying that everything is in order, the CBot 40 initiates the charging operation with the EV 10. Additionally, the CBot 40 may communicate a charging status to the system controller 32 indicating, for example, that the connection process has been successfully completed, that the charging operation has commenced, and a charge level of the EV's battery, etc. In some cases, the system controller 32 may communicate such information to the EV's driver (e.g., via text message, or via an associated charging app).

In examples, upon completing the charging operation, the CBot 40 automatically disconnects from the now-charged EV 10 and communicates to system controller 32 that the charging operation of the assigned EV 10 has been completed. Additionally, the CBot 40, in examples, communicates its status to system controller 32, where such status communication may include various data such as the availability of the CBot 40 to perform another charging operation, a state of charge (SoC) of the onboard charging battery pack 42, an amount of energy transferred to the just-charged EV 10 (which the system controller 32 may employ for billing purposes), etc. In examples, based on the SoC of the battery pack 42 of the CBot 40, the system controller 32 may determine whether to direct the CBot 10 to perform a charging operation of another EV 10, or to direct the CBot 10 to the battery storage and charging facility 34 to swap out the spent battery pack 42 with a fully charged battery pack 42.

In some examples, the BIU 46 automatically connects directly to the charging port 14 of the EV 10, such as via a controllable articulating arm, for instance (where the CBot 40 communicates with the VCU 12 to “open” the charge port so that it is accessible by the CBot 40). In other examples, the BIU 46 automatically connects to a charging interface unit (CIU) 70 which has been previously coupled to the charging port 14 of the EV 10 (e.g., via a cord and plug connection 72) by the driver, such that the BIU 46 indirectly connects to EV 10 (without directly contacting the EV 10).

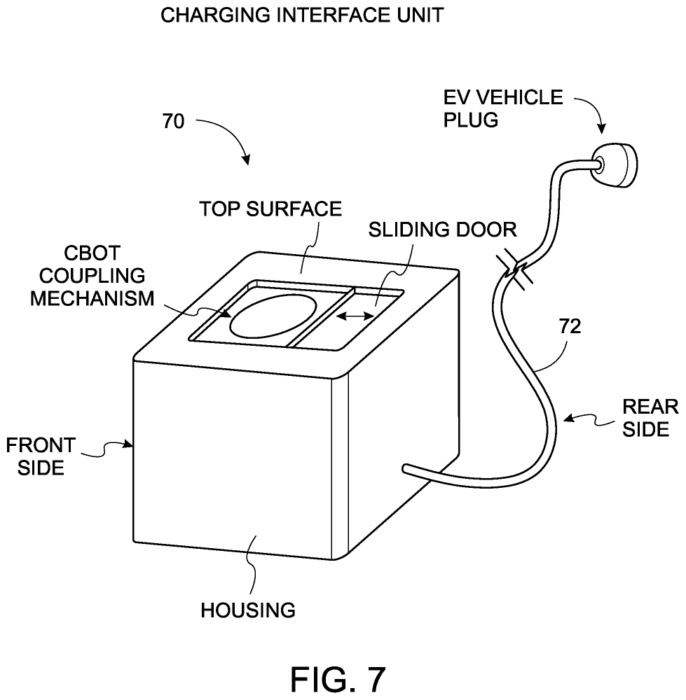

### Charging Interface Unit (See Also FIGS. 7-12 Below)

In examples, the charging interface unit (CIU) 70 is configured to enable the CBot 40 to electrically connect to an EV 10 via a single, standard connection point so that BIU 46 of CBot 40 needs only one type of electrical connector. For example, as will be described in greater detail by FIGS. 7-12 below, an interface receptacle of CIU 70 and a corresponding charging plug of BIU 46 of CBot 40 include all necessary electrical connections to enable the CBot 40 to carry out any suitable type of charging operation with EV 10 (e.g., Level 1, Level 2, DC fast charge, etc.) via the single type of connection point provided by CIU 70.

In examples, CIU 70 is electrically connected to the charging port 14 of an EV 10 via a cord connection 72, wherein CIU 70 includes a receptacle or coupling mechanism which mates with a corresponding coupling mechanism of the BIU 46 of the CBot 40. In some examples, coupling mechanisms of the CIU 70 and the BIU 46 self-align during the coupling process (e.g., electromagnetically). In other examples, the BIU 46 includes an optical sensing unit to optically align the coupling mechanism of the BIU 46 with the coupling mechanism of the CIU 70 (e.g., by identifying LEDs or other alignment features on the CIU). In examples, electrical connections between the coupling mechanisms of the BIU 46 and CIU 70 comprise electrical contacts which are electromagnetically held together during the charging process. Upon completion of the charging process, the electromagnetic connections are released to enable the CBot 40 to disconnect from the CIU 70.

In some examples, the CIU 70 includes a cord 72 having a plug which is inserted into the charging port 14 of the EV 10 by the driver after parking. The CIU is then placed by the driver at a designated location which is accessible by the CBot, such as adjacent to a rear of the unit (e.g., see FIG. 1). In examples, CIU 70 may be a device that a driver stores in a trunk of the EV 10, or may be a device that is disposed at each parking space 8 for driver use.

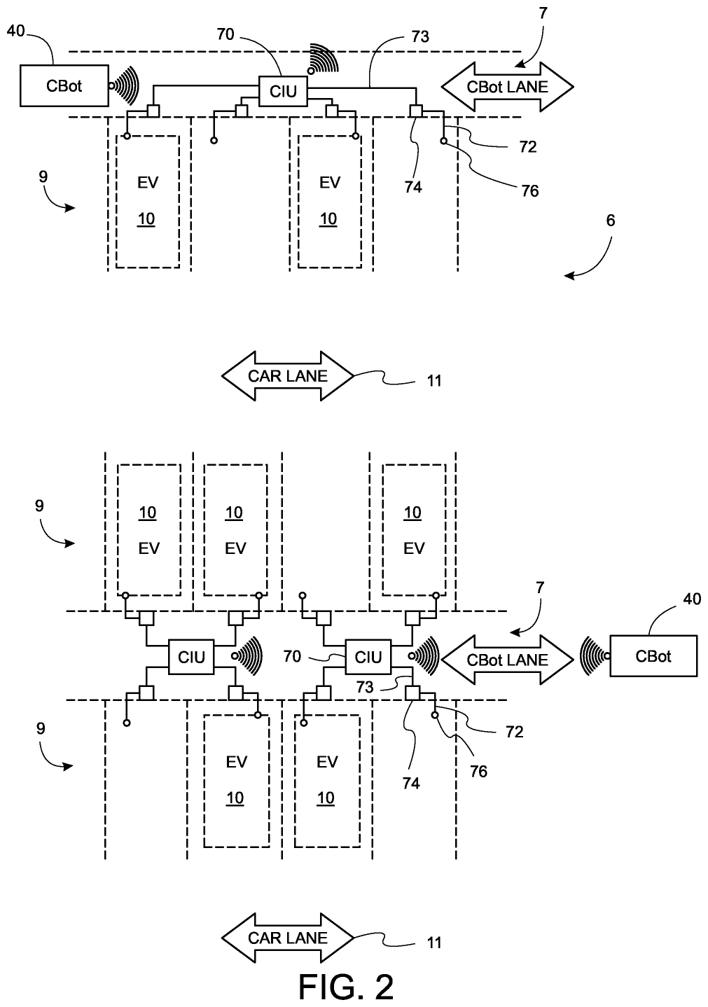

In other examples, as will be illustrated in greater detail below by FIG. 2, the parking facility 6 may include a number of CIUs 70 which are disposed at fixed locations which are accessible by the CBots 40, and where each CIU 70 may be associated with one or more parking spaces 8 within the parking facility (e.g., 2 or 4 spaces), and where drivers connect the EV 10 to the CIU 70 by connecting charging cords disposed at each corresponding parking space 8 to the charging port 14 of EV 10. In some examples, the CIU 70 is able to separately electrify (e.g., via contactors) each charging cord connected thereto to enable scheduled charging of multiple EVs 10 connected to the CIU 70. In some examples, each CIU 70 has a unique identifier and location which is used by the CBot 40 to maneuver itself to the location of the CIU 70 to carry out charging of corresponding EVs 10 connected thereto. In one example, each EV 10 is identified based on a CIU 70 into which the EV 10 is plugged (as described in greater detail below by FIG. 2). In examples, each CIU 70 may be identified via an RFID tag disposed thereon which is read by the CBot 40. In other examples, each CIU 70 identifies itself by wirelessly transmitting its unique identifier which is received by CBot 40 when within range of the CIU 70.

FIG. 2 is a block and schematic diagram generally illustrating a portion of parking facility 6, according to one example, where a plurality of CIUs 70 are disposed along CBot pathways or lanes 7 that extend along and/or between rows of parking spaces 9 in the parking facility 6. In the illustrated example, each CIU 70 is electrically connected via wiring 73 (e.g., via underground wiring) to a number of charging posts 74 (4 charging posts in the illustrated example) where each charging post 74 is located proximate to a corresponding parking space and includes cord 72 and plug 76 for connecting to a charging port of an EV 10. In examples, each CIU 70 is electrically powered (e.g., via a hardwired electrical connection to a power source or via an integral battery), and is in communication with system controller 32 and/or the EV 10, such as via wireless communication (as illustrated).

In examples, CIU 70 may be disposed partly below ground such that the CBots 40 are able to drive over the CIUs 70 and connect thereto via a connection device (e.g., a “drop down” device) that is part of the BIU 46 (see FIG. 1). In examples, the CIU 70 is able to selectively energize each of the corresponding charging cables 72 so as to selectively charge a respective EV 10 connected thereto as directed by system controller 32 according to the charging schedule 62. In examples, each CBot 40 is able to successively and/or simultaneously charge multiple EVs 10 connected to a same CIU 70 without the need for the CBot 40 to change locations (e.g., drive to a different location). It is noted that in other examples, dedicated CBot pathways 7 may not be employed, that fewer or more than four charging cords/parking spaces may be associated with each CIU 70, and that the CIUs 70 may be disposed at locations other than those illustrated (e.g., in the car lanes).

### Battery Storage and Charging Facility

In examples, each CBot 40 continually monitors a state of charge (SoC) of its onboard charging battery pack 42 (see FIG. 1). Upon the charging battery pack 42 becoming depleted (e.g., below a predetermined threshold charge, or below a certain charge level at which point), the system controller 32 determines that the CBot 40 is unable to charge any designated EV on the charging schedule and instructs the CBot to obtain a fresh battery. The CBot 40 then autonomously maneuvers to the battery pack charging and storage facility 34 to obtain a fresh charging battery pack 42 (i.e., a charged battery pack). In one example, the CBot 40 automatically exchanges the depleted charging battery pack with a charged battery pack. In another example, the CBot 40 charging battery pack 42 is recharged while remaining mounted to the CBot 40.

In some examples, battery storage and charging facility 34 includes a supply of charged battery packs 42, where the charged battery packs 42 may be stored at designated locations on one or more battery charging and storage racks 80. In operation, a CBot 40 having a depleted charging battery pack 42 is instructed by a battery charging control unit (BCCU) 82 to deliver its depleted battery 42 to a designated location on battery storage rack 80 (i.e. an empty location). In one example, upon reaching the designated location, the depleted charging battery pack 42 is automatically unloaded from the CBot 40 onto the battery rack 80, where the depleted charging battery pack 42 will be automatically recharged by a battery charging system 84. After unloading the depleted battery 42, the CBot 40 retrieves a charged battery pack 42 from a different designated location on battery rack 80 as instructed by BCCU 82. In examples, the charged battery pack 42 is automatically transferred from the battery rack 80 to the CBot 40, at which point the CBot 40 notifies the system controller 32 that it is once again available to perform charging operations. In examples, the CBot 40 includes mechanisms for placing depleted battery packs 42 onto, and retrieving charged battery packs 42 from, the battery storage racks 80 and/or the battery racks 80 include mechanisms for removing depleted battery packs 42 from, and placing charged battery packs 42 onto, the CBots 40.

In some examples, battery rack locations operate in pairs on opposing racks which are disposed on opposite sides of a CBot pathway with charging and storage facility 34. According to such example, when exchanging charging battery packs, the depleted charging battery pack is automatically unloaded to an empty battery rack location on one side of the CBot, and a charged battery pack is loaded onto the CBot from an opposing battery rack location on the opposite side of the CBot so that the CBot may remain at a single location during the battery unloading and loading process (see FIG. 4). In such fashion, a battery rack location holding a charged battery pack is always paired with an opposing empty battery rack location on the opposite side of the CBot pathway. It is noted that, based on charging times, a total number of charging battery packs 42 that is less than twice the number of CBots 40 being employed may be used to keep a fleet of CBots 40 operational. For example, a fleet of 8 CBots may be operated continuously using only 12 batteries.

The battery charging system 84 may employ any suitable charging process for charging the battery charging packs 42 stored in the battery charging racks 80 (e.g., Level 2, DC fast charging, etc.).

In some cases, in lieu of loading and unloading battery packs 42 to/from the CBots 40, the depleted charging battery packs are charged while remaining mounted on a CBot 40. In some examples, the CBot 70 is instructed to drive to a designated charging location, where a charging connection is automatically made between the facility battery charging system 84 and the charging battery pack 42 (e.g., using a CIU similar to those employed for charging EVs). According to such a scenario, a battery rack and battery transfer system is not required, but a CBot may be unavailable to charge EVs for a longer period of time while the battery is being charged as opposed to a system where a depleted battery is swapped out with a charged battery via a battery rack system.

The battery charging and storage facility 34 may have a modular configuration, where additional battery racks 80, battery charging locations, and battery charging system 84 are readily expandable.

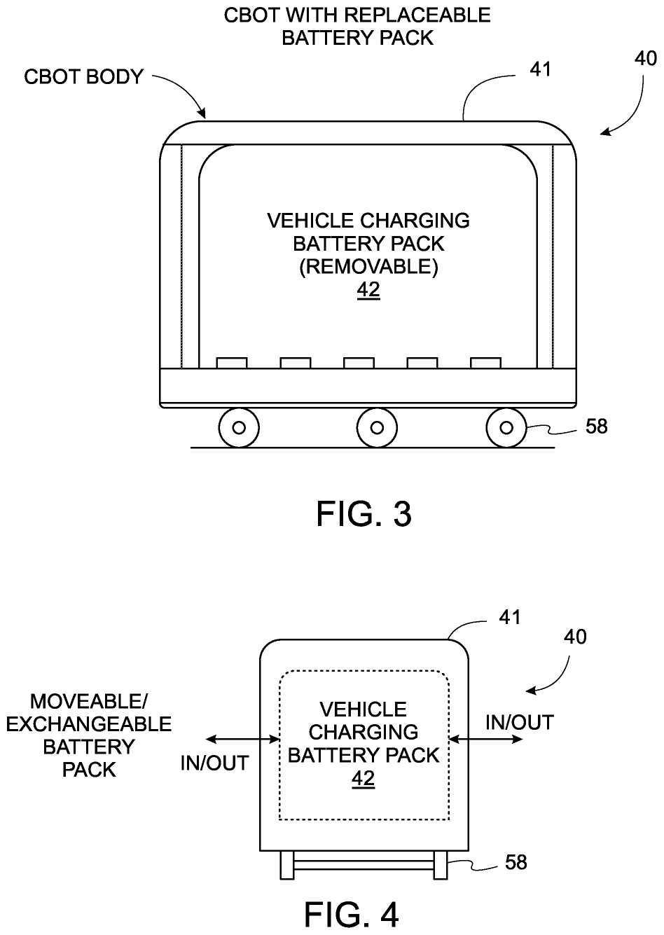

FIGS. 3-12 below are block and schematic diagrams illustrating examples of CBot 40 and charging interface unit (CIU) 70, in accordance with the present disclosure.

FIGS. 1-3 are block and schematic diagrams generally illustrating examples of CBot 40, in accordance with the present disclosure. In examples, CBot 40 includes charging battery pack 42, bot control unit (BCU) 44, and a drive system 52 which are housed within a body 41.

CBOT with Vehicle Charging Battery

As described above, according to examples, CBot 40 is suitable for use to charge one or more EVs 10, or as part of a coordinated electric vehicle charging system, such as charging system 30 (see FIG. 1). In examples, CBot 40 is autonomous and operates free of a track system to drive to identified parking locations within a parking facility. The CBot 70 then performs a desired charging operation of an EV 10 at the identified parking location. In one example, as illustrated by the block and schematic diagram, CBot 70 includes a bot control unit (BCU) 46, exchangeable on-board charging battery pack 42, and a drive system 52, where one or more features of such CBot elements are described below.

### Charging Battery Pack

In examples, charging battery 42 is made up of one or more rechargeable batteries 43. In one example, the batteries 43 are configured from a suitable rechargeable battery technology (e.g., lithium-ion batteries). The charging battery pack 42 provides the energy to charge a rechargeable battery 18 of EV 10 at charging location, such as parking space 8 (see FIG. 1). Additionally, the charging battery pack 42 can power the drive system 52 and BCU 44 of CBot 40. In examples, charging battery pack 42 can be configured to have any number of operating voltage levels (e.g., 400 VDC) and capacities.

### Bot Control Unit (BCU)

In examples, BCU 44 operates to control the operation of CBot 40. In examples, at a CBot charging location (e.g., charging and storage facility 34 of FIG. 1), BCU 44 coordinates recharging of the charging battery pack 42 or exchanging of a depleted charging battery pack 42 for a charged battery pack (e.g., such as from battery storage rack 80). In examples, at an EV 10 charging location, BCU 44 coordinates charging of EV battery 18. In examples, BCU 44 communicates with internal and external units via wired or wireless communication links. In one example, BCU 44 communicates with external devices using one or more wireless communication links (e′g′, a bluetooth or bluetooth low energy communication link).

### Drive System.

In examples, CBot drive system 52 includes one or more electric motors 54, each having a corresponding controllable drive unit (motor controller) 56 to drive directionally controllable wheels 58. In one case, the BCU 44 controls operation of drive system 52 (as well as a steering system) to control movement of CBot 40 about parking facility 6 (e.g., between a CBot charging location and an EV charging location).

With reference to FIGS. 3 and 4, in some examples, as described above, charging battery pack 42 is removable/exchangeable from CBot 40. After completing one or more charging operations of EVs 10, charging battery pack 42 will need to be recharged. In examples, BCU 44 controls moving the CBot 40 to a CBot charging location and controls a charging operation of charging battery pack 42. In one example, the charging battery pack 42 is maintained on the CBot 40 while it is recharged. In another example, the drained charging battery pack 42 is replaced with a charged battery pack 42 (e.g, from battery storage rack 80), wherein after removal, the drained charging battery pack 42 is maintained and recharged at the battery charging location.

With reference to FIG. 6, according to examples, in addition to charging battery pack 42, Bot Control Unit (BCI) 46, and drive system 52, CBot 70 includes a Bot battery 90, a Bot charging interface (BCI) 92, a supply side converter 94, a load side converter 96, and a cooling system 98.

### Bot Battery

According to examples, CBot 40 includes a bot battery 90 separate from charging battery pack 42, and which can be separately charged, or be charged using the charging battery pack 42. In examples, a DC-DC converter (not illustrated) can be disposed between the vehicle charging battery pack 42 and bot battery 90 if the vehicle charging battery 42 is a high voltage (e.g., 220 volts or higher) DC battery and bot battery 90 is relatively lower voltage (e.g., 12-16 V) DC battery. In examples, the bot battery 90 powers on-board devices such as the bot control unit 44, operating lights, a cooling pump, and other devices. In other examples, some on-board devices may be powered by bot battery 90 (e.g., BCU 44, operating lights, etc.), and other on-board devices may be powered by the vehicle charging battery pack 42 (e.g., drive system 52, cooling pump/cooling system components).

### Bot Charging Interface (BCI)

In examples, BCI 92 serves as a plug/port interface on a supply side of CBot 40 between the CBot 70 and an external power supply. In some examples, if the vehicle charging battery pack 42 is charged while located on CBot 40, vehicle charging battery pack 42 is charged via BCI 92. In other examples, if a depleted battery pack 42 is removed for charging, the BCI 92 may be located on the vehicle charging battery pack 42 for charging of the vehicle charging battery pack after removal from CBot 40.

### Bot Interface Unit (BIU)

In examples, as also described above by FIGS. 1-2, BIU 46 serves as the charging port/load side interface between the CBot 40 and an EV 10 to be charged. In some examples, as described above, BIU 46 operatively couples the CBot to a CIU 70 located at or near the EV 10 to be charged. In one example, BIU 46 is located on a bottom-side of CBot 40, wherein CBot 40 positions itself so that BIU 46 is disposed over CIU 70 for coupling of BIU 46 to CIU 70 to perform a charging operation of an EV 10.

### Supply Side Converter

In examples, CBot 40 includes a supply side converter 94 which is used to convert incoming AC voltage to the DC voltage requirement of the vehicle charging battery 42. Alternatively, supply side converter could convert 94 incoming voltage from a DC supply voltage to the DC voltage requirement of the vehicle charging battery 42.

### Load Side Converter

In examples, CBot 40 includes a load side converter 96 which is used to match the supply voltage from the vehicle charging battery 42 to the voltage requirements of the EV battery 18 of the EV 10 to be charged. In one example, load side converter 96 includes DC-DC converter 48 and/or DC-AC converter 50 (see FIG. 1 above). In some examples, CBot 40 may not employ a load side converter 96.

### Cooling System

In examples, CBot 40 includes a cooling system 98 to cool vehicle charging battery 42 to prevent overheating of vehicle charging battery 42 during battery operation. In one aspect, cooling system 98 includes a coolant reservoir, a cooling pump, and delivery system for moving coolant through the vehicle charging battery 42. In one example, the cooling system is a closed loop system.

### Battery Pack Removal System

In one example, the CBot 40 includes a battery removing system designed for removing the vehicle charging battery pack 42 from CBot 40 for recharging. In one example, the removable battery pack system includes a cbot structure design that allows a central charging rack to remove the vehicle charging battery pack 42 from CBot 40, place it in a charging location (e.g., charging and storage rack 80 of FIG. 1), and replace it with a charged vehicle charging battery pack.

### Charging Interface Unit (CIU)

FIGS. 7-12 below are block and schematic diagrams generally illustrating CIU 70, according to examples of the present disclosure. In examples, CIU 70 is used to electrically couple CBot 70 to an EV 10 for delivery of charging power from charging battery pack 42 to charge EV battery 18 of the EV 10 to be charged. In one example, the CIU 70 couples (i.e., plugs into) to the charging port 14 of EV 10 (see FIG. 1). In examples, CBot 70 electrically couples to CIU 70 for performing a charging operation on the associated EV 10. In one example, CBot 40 moves vertically over the top of CIU 70 to electrically couple to CIU 70 via BIU 46. In another example, CBot 40 moves near the CIU 70 and performs an electrical coupling operation to electrically couple to CIU 70 (e.g., via an articulating arm). In one or more examples, the CBot 40, via BIU 46, magnetically or mechanically couples to CIU 70.

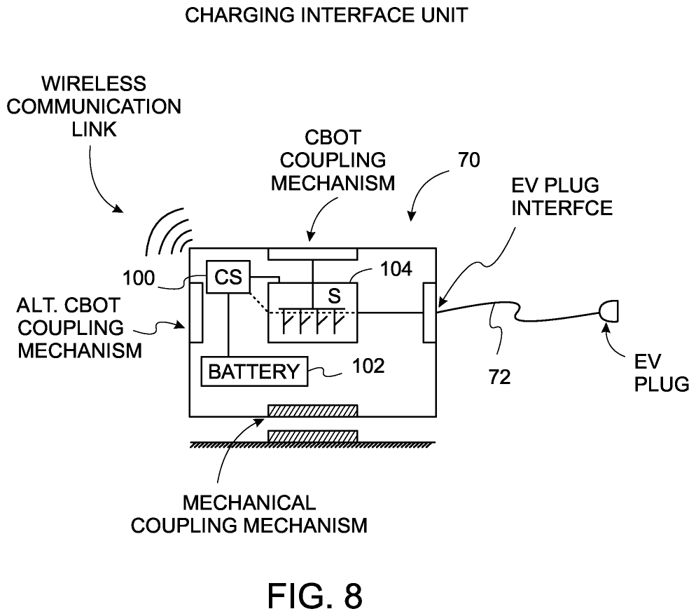

In examples, with reference to FIG. 8, CIU 70 comprises a smart unit including an on-board control system (CS) 100. In some examples, CIU 70 includes an on-board battery 102 for providing power to CIU 70. In examples, battery 102 may be a replaceable battery, or may be charged when coupled to a CBot 70 during a charging operation of an EV 10. In examples, CIU 70 may also contain a number of other charging related devices, such as a converter for converting input and output charging voltages, and a switching system 104 for completing an electrical connection between a CBot 40 and one or more EVs 10 waiting to be charged.

In some examples, CIU 70 may serve a single parking space or multiple parking spaces (e.g., 2 or 4). In examples, CIU 70 may be portable, and in certain applications may be stored in a vehicle trunk when not in use. In another application, CIU 70 may be permanently mounted at fixed locations within a parking facility (e.g., see FIG. 2). In some examples, CIU 70 may be wall mounted, post mounted or floor mounted. In each application, the CIU 70 is positioned at a location suitable for coupling to a CBot 40 or another similar charging device.

### Example Operation

In one example, such as illustrated above by FIG. 2, CIU 70 may be coupled to 4 EVs, wherein the CIU 70 is able to selectively electrically couple 4 vehicles to a same CBot 40. In operation, according to one example (see FIG. 2), CIU 70 is coupled to 4 EVs 10 located in nearby charging spaces which have requested charging. A CBot 40 communicates with the CIU 70 (e.g., using a wireless communication link) and the EVs 10 vehicles, and moves to the charging location.

In one example, the CBot 40 moves over CIU 70 and mechanically and electrically couples to the CIU 70 in preparation of performing multiple vehicle charging operations. In examples, CIU 70 communicates with the system controller 32, CBot 40, and the VCU 12 of the EVs to be charged and controls switching system 104 to coordinate charging of multiple vehicles EVs 10 (e.g., sequential charging of EVs connected to the CIU 70) using a single CBot 70 and a single CIU 70. Once a charging operation is complete, the CBot 70 disconnects from the CIU 70 and moves to either another changing location or returns to the battery pack storage location 34 for replacement of the CBot vehicle charging battery 42.

In some examples, as described below, various devices may be employed to interface with charging ports 14 of EVs 10 to enable different functionality or connections.

EV charging port extender. Charging port extender provides a charging port at a location and type that works with a specific charging location or CBot. For example, a conventional charging port may be located on a side of an EV. The port extender may extend the port location to the front or rear of a vehicle which can be more suitable for overnight charging through the use and location of a charger or CBot.

Charging plug converter. Converts conventional receptacle/plug-in type charging outlet to other more useful EV outlet such as a magnetic contact or other direct contact charging outlet.

Charging port assembly. Charging plug has a coil and charge port has a coil. In one sequence, first they inductively couple then electrically couple through direct contact or electromagnetically couple. Two stage coupling.

EV Vehicle Charging Port that gives one the ability to switch between AC Charging and DC charging. Could also be two separate side-by-side receptacles or ports or locations, one AC and one DC. Could manually switch between the two or could have a switch mechanism controlled by the on-board vehicle control system or an app.

Enhanced charging port suitable for CBot/Commercial/Specific charging set-up. Could use a charging port extender between the enhanced charging port and the vehicle battery system.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The following claims are part of the specification.

1. (canceled)

2. An electric vehicle charging system comprising:
a system controller;
an autonomous charging robot having a charging battery pack, where the autonomous robot communicates with the system controller for selectively charging an electric vehicle requesting a charge using the charging battery pack.

3. The electric vehicle charging system of claim 2, comprising:
where the charging robot drives to the selected electric vehicle as directed by the system controller, the charging robot including an interface unit to automatically couple to a charging port of the selected electric vehicle.

4. The electric vehicle charging system of claim 2, comprising:
where the system controller communicates with a plurality of electric vehicles, each electric vehicle requesting a charging operation to charge a vehicle battery pack of the electric vehicle, the system controller to:
generate a charging schedule including an order in which the electric vehicles are to be charged based on a plurality of charging factors; and
select from the charging schedule the electric vehicle for charging.

5. The electric vehicle charging system of claim 2, comprising:
where the charging battery pack is an exchangeable battery pack.

6. The electric vehicle charging system of claim 2, comprising:
the autonomous charging robot comprising:
the charging battery pack;
an on-board bot control unit;
a bot interface unit; and
a battery powered drive system; and
where the battery powered drive system is controlled by the bot control unit to autonomously drive and maneuver the charging robot between a battery pack charging facility and the electric vehicle requesting a charge.

7. The electric vehicle charging system of claim 6, comprising:
where the charging robot automatically couples the charging battery to the electric vehicle requesting a charge via the bot interface unit and automatically charges the electric vehicle via the charging battery.

8. The electric vehicle charging system of claim 7, the charging robot comprising a charging arm for automatically coupling the charging robot to an electric vehicle charging port.

9. The electric vehicle charging system of claim 8, where the charging arm is a controllable articulating arm.

10. The electric vehicle charging system of claim 6, the charging robot further comprising a DC-DC converter and a DC-AC converter for converting the battery voltage to an electric vehicle target charging voltage.

11. An electric vehicle charging system comprising:
a system controller to communicate with a plurality of electric vehicles, each electric vehicle requesting a charging operation to charge a vehicle battery pack of the electric vehicle, the system controller to:
generate a charging schedule including an order in which the electric vehicles are to be charged based on a plurality of charging factors; and
select from the charging schedule an electric vehicle for charging; and
at least one autonomous charging robot having a charging battery pack, the charging robot to drive to the selected electric vehicle as directed by the system controller, the charging robot including a bot interface unit to automatically couple to a charging port of the selected electric vehicle and charge the vehicle battery pack from the charging battery pack.

12. The electric vehicle charging system of claim 11, comprising:
a charging interface unit configured to couple to one or more electric vehicle charging ports; and where the autonomous robot couples to the electric vehicle via the charging interface unit thereby providing a single connection point between the charging robot and the electric vehicle charging ports.

13. The electric vehicle charging system of claim 12, comprising:
the charging interface unit comprising a bot coupling mechanism that allows the charging robot to automatically couple to the charging interface unit.

14. The electric vehicle charging system of claim 13, comprising a charging cable extending from the charging interface unit for coupling the charging interface unit to an electric vehicle requesting a charging.

15. The electric vehicle charging system of claim 13, where the bot coupling mechanism includes a controllable door for allowing controlled access to the charging interface unit by a charging robot.

16. The electric vehicle charging system of claim 13, where the charging interface unit includes a control system that wirelessly communicates with the system controller.

17. The electric vehicle charging system of claim 13, the charging interface unit comprising multiple charging cables extending from the charging interface unit for coupling a charging robot to multiple electric vehicles requesting a charge via the charging interface unit.

18. The electric vehicle charging system of claim 13, comprising a unique identifier associated with the charging interface unit that allows the charging robot to locate the charging interface unit and mechanically couple to the robot coupling mechanism.

19. The electric vehicle charging system of claim 13, comprising where the charging interface unit has a top surface, and the coupling mechanism is accessible at the top surface, and where during a charging operation the charging robot is positioned over the charging interface unit and electrically coupled to the coupling mechanism.

20. The electric vehicle charging system of claim 19, where the coupling mechanism is a magnetic port and the charging robot includes a bot interface unit that is an electromagnetic coupling device that electromagnetically couples the charging bot to the coupling mechanism magnetic port.

21. An electric vehicle charging system comprising:
a system controller;
an autonomous charging robot having a charging battery pack, where the autonomous robot communicates with the system controller for selectively charging an electric vehicle using the charging battery pack, where the charging robot drives to the selected electric vehicle as directed by the system controller, the charging robot including an interface unit to automatically couple to a charging port of the selected electric vehicle,
where the system controller communicates with a plurality of electric vehicles, each electric vehicle requesting a charging operation to charge a vehicle battery pack of the electric vehicle, the system controller to:
generate a charging schedule including an order in which the electric vehicles are to be charged based on a plurality of charging factors; and
select from the charging schedule the electric vehicle for charging;
the autonomous charging robot comprising:
the charging battery pack;
an on-board bot control unit;
a bot interface unit; and
a battery powered drive system; and
where the battery powered drive system is controlled by the bot control unit to autonomously drive and maneuver the charging robot between a battery pack charging facility and the electric vehicle requesting a charge; and
where the battery pack charging facility includes a battery rack configured to automatically unload a depleted charging battery pack and automatically load a charged charging battery pack onto the charging robot.
